(19) United States
(12) Patent Application Publication
(10) Pub. No.: US 2012/0161914 A1
(43) Pub. Date: Jun. 28, 2012

(54) TRANSFORMER

(75) Inventors: Hee Soo Yoon, Suwon (KR); Hee Soo Kim, Yongin (KR); Dong Jin Kim, Gwangmyeong (KR); Kyu Hwan Oh, Suwon (KR); Kyung Ho Lee, Suwon (KR); Kyoung Ho Lee, Hwaseong (KR); Su Bong Jang, Anyang (KR); Jeong Ho Yoon, Seongnam (KR); Dong Hwan Lee, Suwon (KR)

(73) Assignee: SAMSUNG ELECTRO-MECHANICS CO., LTD.

(21) Appl. No.: 13/335,377

(22) Filed: Dec. 22, 2011

(30) Foreign Application Priority Data
Dec. 24, 2010 (KR) 10-2010-0134164

(51) Int. Cl. H01F 27/28

(52) U.S. Cl. 336/200

(57) ABSTRACT

There is provided a transformer having a minimized thickness. The transformer includes: insulating layers; and coil units including primary and secondary coils disposed on the insulating layers to have a common center.

### CROSS-REFERENCE TO RELATED APPLICATIONS

This application claims the priority of Korean Patent Application No. 10-2010-0134164 filed on Dec. 24, 2010, in the Korean Intellectual Property Office, the disclosure of which is incorporated herein by reference.

### BACKGROUND OF THE INVENTION

1. Field of the Invention

The present invention relates to a transformer having a minimized thickness and overall size.

2. Description of the Related Art

In accordance with the recent trend for the compactness, lightness and digitalization of electronic devices, chip-type electronic components capable of being surface-mounted on a substrate have been manufactured. Accordingly, chip-type LC composite filters, transformers, and the like, as well as chip-type basic elements such as resistors, condensers, inductors, and the like, have been manufactured.

According to the related art, as a method for manufacturing a transformer, a process in which coils are wound around both sides of a magnetic core has been used; however, research into a method for manufacturing a chip-type transformer has been conducted as the size of the electronic device has been reduced.

According to the related art, a transformer has been manufactured by printing internal electrode patterns on respective magnetic green sheets and stacking the magnetic green sheets. At this time, a primary coil and a secondary coil are printed on the individual green sheets, and the green sheets are then stacked, wherein the primary and secondary coils are electromagnetically coupled by a ferrite magnetic path formed in an inner portion of the transformer.

However, the transformer according to the related art has been generally configured such that the primary and secondary coils thereof are disposed on different layers as described above, thereby resulting in a large thickness.

### SUMMARY OF THE INVENTION

An aspect of the present invention provides a transformer having a minimized thickness.

In addition, another aspect of the present invention provides a multilayer transformer capable of providing various levels of voltage through a single transformer.

According to an aspect of the present invention, there is provided a transformer including: insulating layers; and coil units including primary and secondary coils disposed on the insulating layers to have a common center.

The insulating layer may be formed by firing magnetic green sheets.

A plurality of insulating layers including the coil units disposed therein may be stacked.

The plurality of insulating layers may include at least one via electrically connecting the coil units disposed in adjacent insulating layers.

The individual coil units disposed in the plurality of stacked insulating layers maybe electrically connected to each other.

At least one of the primary and secondary coils may be formed as a continuous single coil pattern.

At least one of the primary and secondary coils may include a plurality of independent coil patterns.

The secondary coil may be disposed in an inner portion of the primary coil.

The transformer may further include a plurality of exposed electrodes formed on a lower surface of the insulating layer and electrically connected to the coil units.

According to another aspect of the present invention, there is provided a transformer, including: a core unit formed by stacking a plurality of insulating layers; and coil units including primary and secondary coils disposed to have a common center on at least one insulating layer of the plurality of insulating layers.

The insulating layers may be formed of magnetic green sheets, and the core unit may be formed by firing the stacked insulating layers.

At least one of the primary and secondary coils may be disposed in the individual insulating layers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a transformer according to an exemplary embodiment of the present invention;

FIG. 2 is a cross-sectional view taken along line A-A′ of the transformer shown in FIG. 1;

FIG. 3 is an exploded perspective view of the transformer shown in FIG. 1;

FIG. 4 is a cross-sectional view schematically showing a transformer according to another exemplary embodiment of the present invention; and

FIGS. 5A and 5B are plan views schematically showing a transformer according to another exemplary embodiment of the present invention.

### DETAILED DESCRIPTION OF THE PREFERRED EMBODIMENT

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the meaning of the term to describe most appropriately the best method he or she knows for carrying out the invention. Therefore, the configurations described in the embodiments and drawings of the present invention are merely the most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings. At this time, it is to be noted that like reference numerals denote like elements in appreciating the drawings. Moreover, detailed descriptions related to well-known functions or configurations will be ruled out in order not to unnecessarily obscure the subject matter of the present invention. Based on the same reason, it is to be noted that some components shown in the drawings are exaggerated, omitted or schematically illustrated, and the size of each component does not exactly reflect its real size.

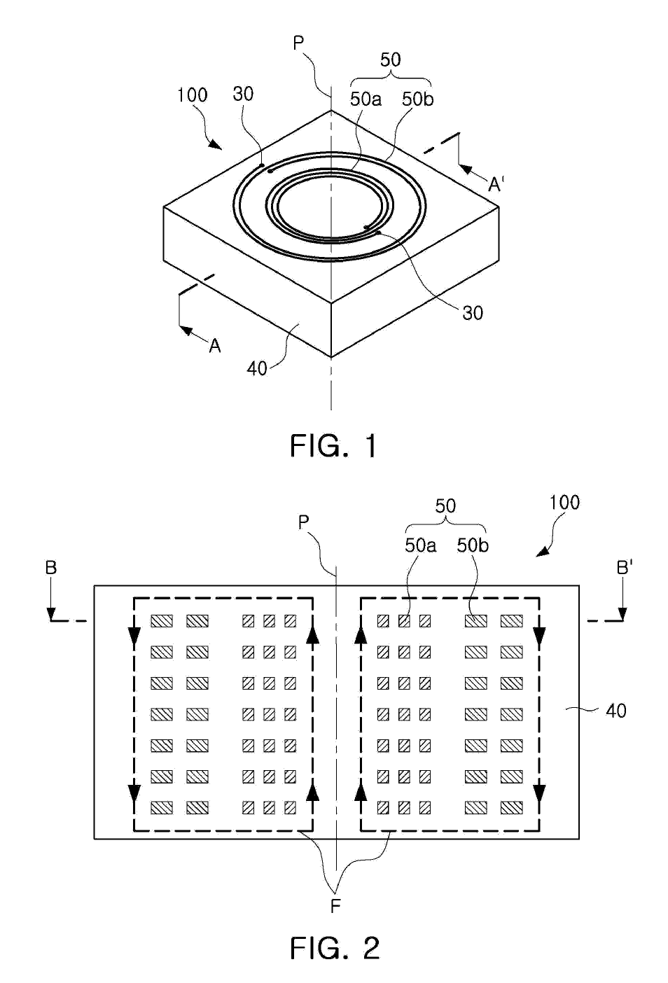

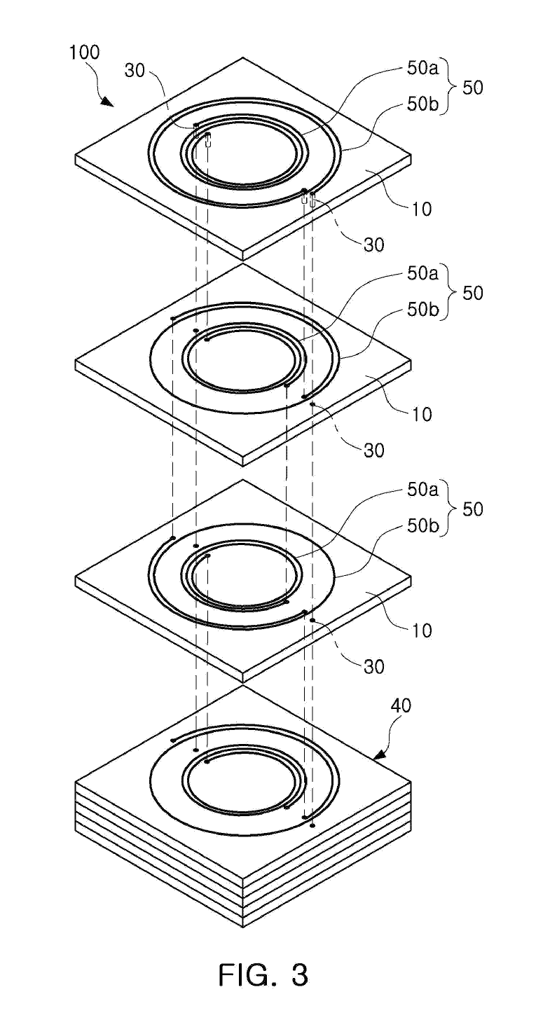

FIG. 1 is a perspective view schematically showing a transformer according to an exemplary embodiment of the present invention, and FIG. 2 is a cross-sectional view taken along line A-A′ of the transformer shown in FIG. 1. FIG. 3 is an exploded perspective view of the transformer shown in FIG. 1.

Referring to FIGS. 1 to 3, a transformer 100 according to an exemplary embodiment of the present invention, which is a chip-type transformer 100 formed by printing coil patterns on magnetic green sheets, is configured to include a coil unit 50 and a core unit 40.

The coil unit 50 may include a primary coil 50a and a secondary coil 50b.

Herein, as described above, in the transformer 100 according to the present exemplary embodiment, the coil patterns are printed on the magnetic green sheets, which are insulating layers, to form the coil unit 50. In the transformer 100 according to the present exemplary embodiment, the primary coil 50a and the secondary coil 50b are disposed together on the same layer. In addition, the primary coil 50a and the secondary coil 50b are disposed to have a common center.

The coil unit 50 according to the present exemplary embodiment has the primary coil 50a disposed in an inner portion thereof and the secondary coil 50b receiving the primary coil 50a therein and being disposed around the circumference of the primary coil 50a.

At this time, both of the primary coil 50a and the secondary coil 50b are formed to have a spiral shape. In addition, the spiral formed by the primary coil 50a and the secondary coil 50b has a common center P.

The primary coil 50a and the secondary coil 50b may be electrically connected to the outside through a lower surface of the transformer 100. Accordingly, a plurality of exposed electrodes (not shown) may be formed on the lower surface of the transformer 100 for electrical connection to the outside. The exposed electrodes are electrically connected to the primary coil 50a and the secondary coil 50b.

In addition, since the transformer 100 according to the present embodiment is formed by printing the coil patterns (that is, the coil unit) on the magnetic green sheets 10, the magnetic green sheets other than the coil unit 50 are formed as the core unit 40.

The core unit 40 is formed by stacking the plurality of magnetic green sheets 10, which are insulating layers. Accordingly, the core unit 40 serves to provide a magnetic path F in which a magnetic flux is formed, while serving to insulate the coils of the coil unit 50.

Referring to FIG. 2, the transformer 100 according to an exemplary embodiment of the present invention has a closed magnetic path F formed by the core unit 40 formed on the upper and lower surfaces of the transformer 100, the core unit 40 formed in an inner portion of the primary coil 50a, and the core unit 40 formed in an outer portion of the secondary coil 50b.

Accordingly, in the transformer 100 according to this exemplary embodiment of the present invention, when voltage is applied to the primary coil 50a, voltage is induced in the secondary coil 50b by a change in a magnetic flux generated along the closed magnetic path F.

The core unit 40 may be made of Mn—Zn based ferrite having high permeability, low loss, high saturation magnetic flux density, stability, and low production cost. That is, the magnetic green sheet 10 according to the present exemplary embodiment maybe preferably made of a ferrite based material. However, in an exemplary embodiment of the present invention, the material of the core unit 40 is not limited thereto.

In the transformer 100 according to the present exemplary embodiment configured as described above, both of the primary coil 50a and the secondary coil 50b are formed on one layer (that is, the magnetic green sheet). Accordingly, the thickness of the transformer 100 may be minimized, as compared to that of the related art transformer in which a primary coil and a secondary coil are separately formed on different layers.

In addition, referring to FIG. 3, the transformer 100 according to the present exemplary embodiment is formed by stacking the plurality of magnetic green sheets 10. At this time, the coil units 50 formed on upper and lower adjacent magnetic green sheets in contact with each other among the plurality of stacked magnetic green sheets 10 should be electrically connected to each other. That is, the primary coil 50a formed on the upper magnetic green sheet should be electrically connected to the primary coil 50a on the lower magnetic green sheet to thereby form a single coil pattern, which is also applied to the secondary coil 50b.

To this end, the individual magnetic green sheets forming the transformer 100 according to the present exemplary embodiment include a plurality of vias 30 made of a conductive material.

The vias 30 may be formed in a plurality of positions in order to implement the respective primary coils 50a and secondary coils 50b as a continuous single coil pattern. For example, as shown in FIG. 3, one end of the primary coil 50a formed on the lower magnetic green sheet may be electrically connected to the other end of the primary coil 50a formed on the upper magnetic green sheet through the via 30. To this end, the other end of the primary coil 50a formed on the upper magnetic green sheet is arranged to be perpendicular to one end of the primary coil 50a formed on the lower magnetic green sheet. Accordingly, the via 30 formed at the other end of the primary coil 50a on the upper magnetic green sheet is electrically connected to one end of the primary coil 50a on the lower magnetic green sheet.

However, the present invention is not limited thereto, but the vias 30 maybe formed in various positions using various methods so long as they may implement the respective primary coils 50a and secondary coils 50b as a single coil pattern.

Hereinafter, a method of manufacturing the transformer 100 according to the present exemplary embodiment will be described with reference to FIGS. 1 through 3.

In a method of manufacturing the transformer 100 according to the present exemplary embodiment, the magnetic green sheet 10 is first prepared.

Then, a plurality of through holes are formed in the magnetic green sheet 10. At this time, the through holes are used to form the vias 30. Accordingly, the through holes are formed in positions corresponding to positions of the vias to be formed.

Thereafter, the coil unit 50 is formed on the magnetic green sheet 10. At this time, the coil unit 50 may be formed by printing conductive paste on the magnetic green sheet 10.

Herein, the magnetic green sheet 10 may be made of ferrite having high permeability. In addition, the conductive paste forming the coil unit 50 may be metals such as Ag, Cu, Au, and the like, having low sheet resistance and capable of being co-sintered with the magnetic green sheet 10.

In addition, the conductive paste is filled in the through holes in a process of printing the conductive paste on the magnetic green sheet 10. Therefore, the plurality of vias 30 are formed to allow for electrical connection between the coil unit 50 on the upper magnetic green sheet and the coil unit 50 on the lower magnetic green sheet in a stacking process.

Then, the plurality of magnetic green sheets 10 each having the coil unit 50 printed thereon is sequentially stacked. Therefore, the individual magnetic green sheets 10 are stacked to be integrally formed, and the coil units 50 printed on the individual magnetic green sheets 10 are electrically connected through the vias 30 to thereby form a continuous single primary coil 50a and a continuous single secondary coil 50b.

Next, the stacked magnetic green sheets 10 are hot pressed to be sintered, thereby forming an integrated stack.

In addition, exposed electrodes are formed on a lower surface of the sintered stack. The exposed electrodes may be formed by applying the conductive paste to the lower surface of the transformer 100.

Thereafter, the exposed electrodes are hardened, and a plating layer (for example, a nickel plating layer, a solder plating layer, or the like) is then formed as needed, thereby manufacturing the transformer 100 according to the present exemplary embodiment.

The transformer 100 configured as described above is not limited to the above-mentioned exemplary embodiments, but may be modified in various forms.

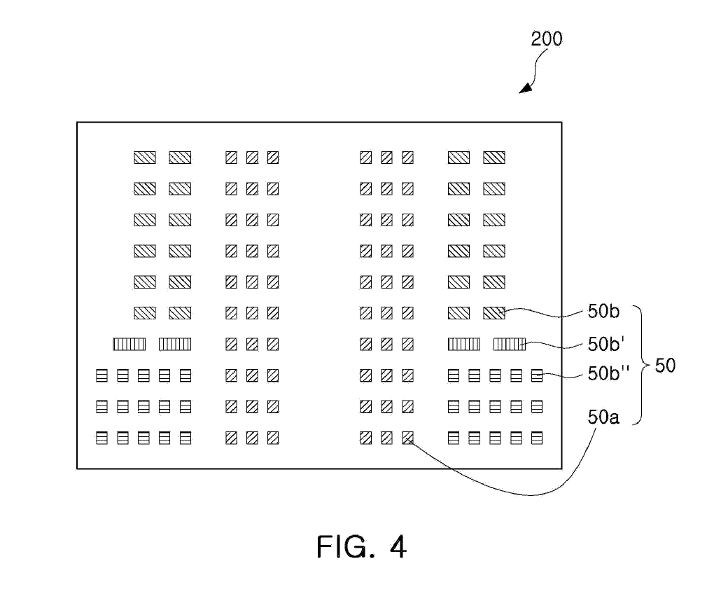

FIG. 4 is a cross-sectional view schematically showing a transformer according to another exemplary embodiment of the present invention. Herein, FIG. 4 is a cross-sectional view corresponding to that of FIG. 2.

Referring to FIG. 4, a transformer 200 according to the present exemplary embodiment is configured to have a similar structure to that of the transformer (100 in FIG. 2) according to the above-mentioned exemplary embodiment, and has a difference only in the configuration of the coil unit 50. Accordingly, a detailed description of the same components will be omitted, and the configuration of the coil unit 50 will be mainly described in detail.

The transformer 200 according to the present exemplary embodiment includes a primary coil 50a formed as a single coil pattern, and a secondary coil 50b formed as a plurality of coil patterns.

That is, the coil unit 50 according to the present exemplary embodiment is configured of one primary coil 50a and a plurality of secondary coils 50b, 50b′, and 50b″ corresponding to the primary coil 50a.

In the case in which the secondary coils 50b, 50b′, and 50b″ are configured as the plurality of independent coil patterns as described above, when voltage is applied to one primary coil 50a, a plurality of different voltages may be drawn. Accordingly, desired voltage may be easily used as needed.

Meanwhile, the present exemplary embodiment has described a case in which the coil unit 50 is configured of one primary coil 50a and the plurality of secondary coils 50b, 50b′, and 50b″ by way of example; however, the present invention is not limited thereto and may have an opposite configuration. That is, the secondary coil may be formed as a continuous single coil pattern and the primary coil corresponding thereto may be formed as a plurality of independent coil patterns.

In this case, a specific coil pattern of the plurality coil patterns forming the primary coil may be selected as needed and voltage may be applied to the selected coil pattern, whereby desired voltage may be drawn through the secondary coil.

In addition, various modifications, such as a case in which both of the primary and secondary coils are formed as a plurality of independent coil patterns rather than a single coil pattern, or the like, may be made.

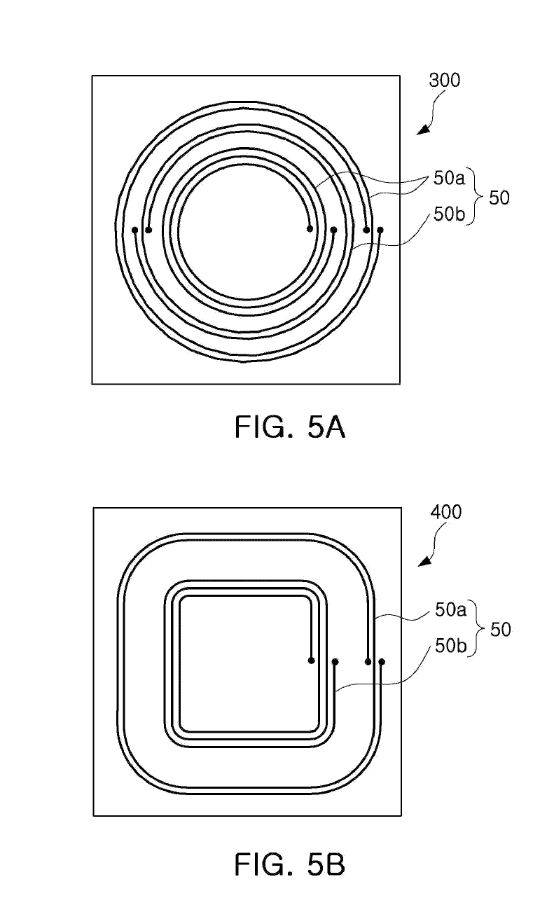

FIGS. 5A and 5B are plan views schematically showing a transformer according to another exemplary embodiment of the present invention.

FIGS. 5A and 5B shows various dispositions of the primary coil 50a and the secondary coil 50b.

First referring to FIG. 5A, a case, in which the coil unit 50 according to the present exemplary embodiment includes the primary coil 50a additionally formed in the outer portion of the secondary coil 50b, is shown by way of example.

In a transformer 300 according to another exemplary embodiment of the present invention, the primary coils 50a or the secondary coils 50b may be repeatedly disposed as needed, which may also be equally applied to other stacked sheets.

In addition, referring to FIG. 5B, the coil unit 50 according to the present exemplary embodiment includes a coil pattern having a rectangular shape, and includes the secondary coil 50b disposed in an inner portion thereof and the primary coil 50a receiving the secondary coil 50b therein and disposed in the outer portion of the secondary coil 50b.

In a transformer 400 according to the present exemplary embodiment, the shape of the coil unit 50 is not limited to a circular shape (that is, a spiral shape); however, the coil unit 50 may have various shapes as needed.

As set forth above, the transformer according to the exemplary embodiments of the present invention is disposed such that the primary and secondary coils have a common center on the same layer. Accordingly, the number of stacked layers may be reduced, as compared to the related art structure in which the primary and secondary coils are disposed on different layers, whereby the thickness of the transformer may be minimized.

In addition, in the transformer according to the exemplary embodiments of the present invention, the primary and secondary coils may be disposed on the same layer, and several layers may be stacked as needed to provide high degree of freedom in design and easily adjust inductance that is to be implemented by the transformer and leakage inductance.

Further, the transformer according to the exemplary embodiments of the present invention may be configured such that the primary or second coils may be formed as a plurality of coil patterns. Accordingly, various levels of voltage may be drawn from a single transformer as needed.

The chip-type transformer according to the exemplary embodiments of the present invention as described above is not specifically limited, but may be variously modified.

For example, the above-mentioned exemplary embodiments have described a case in which both of the primary and secondary coils are disposed on all of the insulating layers, that is, all of the magnetic green sheets by way of example. However, the present invention is not limited thereto.

That is, the transformer may be configured such that the primary and secondary coils may be disposed on at least one insulating layer and only at least one of the primary and secondary coils may be disposed on other remaining insulating layers. At this time, whether or not only the primary coils are disposed on the above-mentioned other remaining insulating layers, whether or not only the secondary coils are disposed thereon, or whether or not both of the primary and secondary coils are disposed thereon may be selected according to the characteristics of the transformer to be manufactured.

In addition, the transformer according to the exemplary embodiments of the invention is formed as a chip-type transformer by way of example; however, the present invention is not limited thereto and may adopt various types of transformers so long as primary and secondary coils can be disposed on the same layer.

As set forth above, in a transformer according to exemplary embodiments of the present invention, primary and secondary coils are disposed to have a common center on the same layer. Accordingly, the number of stacked layers may be reduced, as compared to a structure according to the related art in which the primary and secondary coils are disposed on different layers, whereby the thickness of the transformer may be minimized.

In addition, in a transformer according to exemplary embodiments of the present invention, primary and secondary coils may be disposed on the same layer, and several layers may be stacked as needed to provide a high degree of freedom in design and easily adjust inductance that is to be implemented by the transformer and leakage inductance.

Further, a transformer according to exemplary embodiments of the present invention may be configured such that primary or second coils are formed as a plurality of coil patterns. Accordingly, various levels of voltage may be drawn from a single transformer as needed.

While the present invention has been shown and described in connection with the exemplary embodiments, it will be apparent to those skilled in the art that modifications and variations can be made without departing from the spirit and scope of the invention as defined by the appended claims.

What is claimed is:

1. A transformer comprising:
insulating layers; and
coil units including primary and secondary coils disposed on the insulating layers to have a common center.

2. The transformer of claim 1, wherein the insulating layers are formed by firing magnetic green sheets.

3. The transformer of claim 1, wherein a plurality of insulating layers including the coil units disposed therein are stacked.

4. The transformer of claim 3, wherein the plurality of insulating layers include at least one via electrically connecting the coil units disposed in adjacent insulating layers.

5. The transformer of claim 3, wherein the individual coil units disposed in the plurality of stacked insulating layers are electrically connected to each other.

6. The transformer of claim 4, wherein at least one of the primary and secondary coils is formed as a continuous single coil pattern.

7. The transformer of claim 4, wherein at least one of the primary and secondary coils includes a plurality of independent coil patterns.

8. The transformer of claim 1, wherein the secondary coil is disposed in an inner portion of the primary coil.

9. The transformer of claim 1, further comprising a plurality of exposed electrodes formed on a lower surface of the insulating layer and electrically connected to the coil units.

10. A transformer comprising:
a core unit formed by stacking a plurality of insulating layers; and
coil units including primary and secondary coils disposed to have a common center on at least one insulating layer of the plurality of insulating layers.

11. The transformer of claim 10, wherein the insulating layers are formed of magnetic green sheets, and
the core unit is formed by firing the stacked insulating layers.

12. The transformer of claim 10, wherein at least one of the primary and secondary coils is disposed in the individual insulating layers.
